(19) United States
(12) Patent Application Publication
(10) Pub. No.: US 2009/0196041 A1
(43) Pub. Date: Aug. 6, 2009

(54) ENERGY EFFICIENT LIGHT

(76) Inventors: Peter D. Joseph, Twin Lakes, WI (US); Timothy L. Duitsman, Naperville, IL (US)

Correspondence Address: BRINKS HOFER GILSON & LIONE, P.O. BOX 10395, CHICAGO, IL, 60610, US

(21) Appl. No.: 12/334,723

(22) Filed: Dec. 15, 2008

Related U.S. Application Data
(60) Provisional application No. 61/026,286, filed on Feb. 5, 2008.

(51) Int. Cl. F21V 23/04

(52) U.S. Cl. 362/276

(57) ABSTRACT

An intelligent light, such as a solar or photocell light, is provided. The intelligent light includes a photocell that is in communication with a power source. The photocell receives and converts light energy into electrical energy to charge the power source. A processor is in communication with the photocell. A light source is in communication with the processor. The processor determines an amount of energy charged in the power source and operates the light source as a function of the determined amount of energy.

### RELATED APPLICATION

This application claims priority under 35 U.S.C §119(e) to U.S. Provisional Patent Application No. 61/026,286 filed on Feb. 5, 2008, which is hereby incorporated by reference in its entirety.

### BACKGROUND

Alternative energy sources are being used more frequently. Particularly, solar energy is being harnessed to operate a variety of systems and/or devices. For example, solar lights or lighting systems using solar energy illuminate driveways, pathways, or other surroundings of both residential and commercial properties. Conventional solar lights store energy from sunlight and then run or operate at night based on the stored energy. However, on a cloudy day or a day with reduced sunlight exposure, such as a winter day, the solar light may not be able to store a preferable amount of energy.

### BRIEF SUMMARY

In one aspect, an intelligent light includes a photocell that is in communication with a power source. The photocell receives and converts light energy into electrical energy to charge the power source. A processor is in communication with the photocell. A light source is in communication with the processor. The processor determines an amount of energy charged in the power source and operates the light source as a function of the determined amount of energy.

Other systems, methods, features and advantages of the design will be, or will become, apparent to one with skill in the art upon examination of the following figures and detailed description. It is intended that all such additional systems, methods, features and advantages be included within this description.

### BRIEF DESCRIPTION OF THE DRAWINGS

The components in the figures are not necessarily to scale, emphasis instead being placed upon illustrating the principles of the design. Moreover, in the figures, like referenced numerals designate corresponding parts throughout the different views.

FIG. 1 is a perspective view of a light system;

FIG. 2 is a block diagram illustrating components of a light of the system of FIG. 1;

FIG. 3 is a circuit schematic of the light of FIG. 2;

FIG. 4 is an alternative switching circuit that may be utilized in the light of FIG. 2;

FIG. 5 is a flowchart illustrating a method for controlling a light, such as a light of the system of FIG. 1; and

FIG. 6 depicts the light level associated with one group of exemplary operations of the light system.

### DETAILED DESCRIPTION

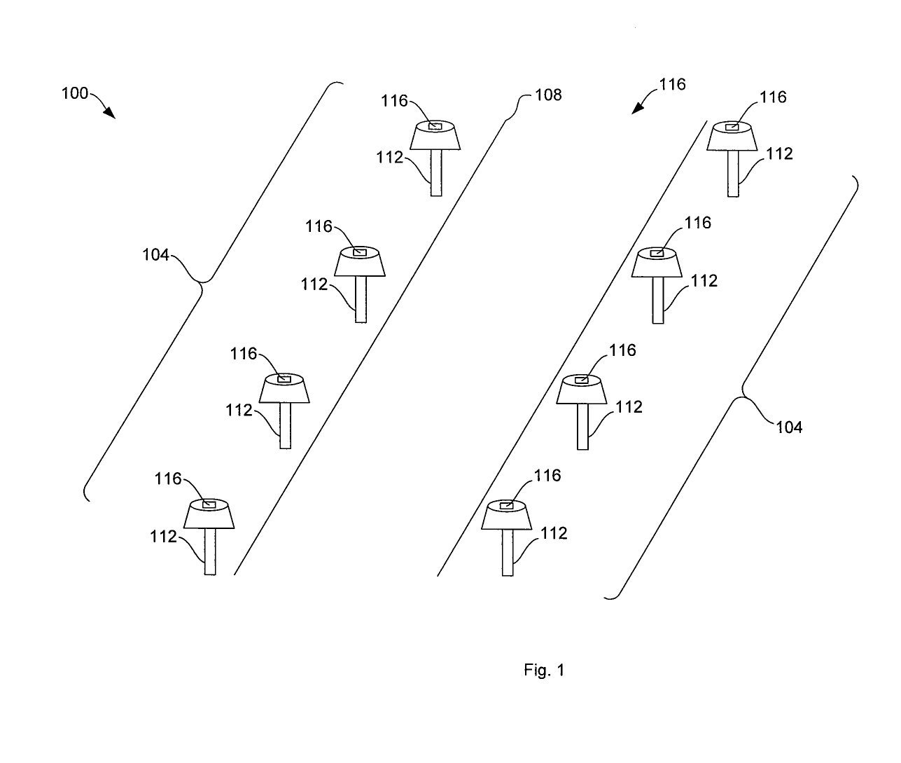

FIG. 1 is a perspective view of a light system 100. The system 100 is an outdoor light system, indoor light system, or other system that produces or emits light. For example, the system 100 is an outdoor lighting system. The system 100 includes, but is not limited to, a plurality of lights 104 and a surrounding 108. Fewer, more, or different components, devices, or features may be provided.

The surrounding 108 may be a pathway, sidewalk, driveway, and/or any other location where sufficient sun light exists to charge a battery via a photovoltaic cell. For example, the surrounding 108 may correspond to a green house or location adjacent to a window. The surrounding 108 may be an area in which people or animals may walk upon or may be an area not to be treaded upon.

The plurality of lights 104 are adjacent or near the surrounding 108. For example, the plurality of lights 104 illuminate the surrounding 108 or areas close to the surrounding 108. The plurality of lights 104 may be arranged in a variety patterns, such as in a row or column sequence, relative to the surrounding 108. Alternatively, the plurality of lights 104 may be placed away from the surrounding 108 or at other outdoor or indoor settings.

Each light 104 includes, but is not limited to, a light fixture 112 and a photocell 116. Fewer, more, or different components may be provided. For example, the light fixture 112 includes a housing to support or enclose a light source, such as a light bulb or one or more light emitting diodes (“LEDs”). The housing is made of conductive and/or non-conductive material. For example, the housing has a metal or plastic frame that surrounds the light source. Glass or plastic acting as a window or pass way to direct or emit light may be supported by the frame. Alternatively, the window or pass way may be one or more opening or holes in the housing. The housing has a substantially cone, rectangular, or other geometrical shape.

The light fixture 112 may also include a support, such as a stand and/or base. The support may be an integral part of the housing or may be a separate part that is attachable to the housing. The support rests on a surface or may be placed under a surface, such as under the ground of an outdoor environment. The light fixture 112 is moveable or transferable and may be placed in various desired locations.

The photocell 116 is supported by the light fixture 112. For example, the photocell 116 is on a top or side surface of the housing. Alternatively, the photocell 116 may be on a base or support of the light fixture 112. The photo cell is a photovoltaic cell, solar cell, photodiode, and/or other device that converts sunlight and/or solar energy into an electrical charge, potential, voltage, and/or current. The photocell 116 on each light 104 may include one or more photocells. The photocell 116 communicates or is electrically connected with other circuitry or components of the light 104.

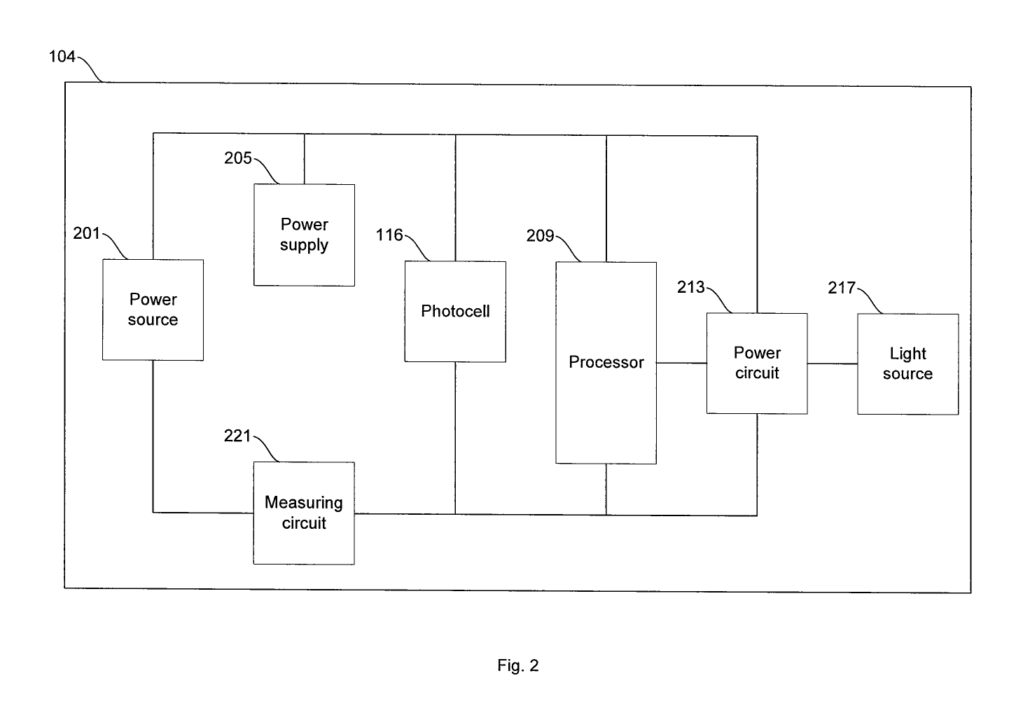

FIG. 2 is a block diagram illustrating components of one of the lights 104. The light 104 includes a power source 201, a power supply 205, the photocell 116, a processor 209, a power circuit 213, a light source 217, and a measuring circuit 221. Fewer, more, or different components may be provided.

The power source 201 is one or more batteries or other device configured to provide electrical energy or potential. For example, the power source 201 is one or more rechargeable batteries, such as a Nickel Cadmium, Lithium ion, or Nickel Metal Hydride based battery. The power source 201 is configured to output at least 2.5 direct current (“DC”) volts. Higher or lower output voltages may be used.

The power supply 205 is connected with the power source 201. The power supply 205 steps up or up converts the DC voltage provided by the power source 201. For example, the power supply 205 increases an input voltage to about 3.3 VDC. The increased voltage is provided to other components or circuits of the light 104. The power supply 205 includes a switching regulator or other device operable to increase a DC voltage.

The photocell 116 is also connected with the power source 201. The photocell 116 charges or stores energy in the power source 201 as function of solar or light energy. For example, during the day or periods of solar or ultraviolet light exposure, the photocell 116 converts such light energy into electrical energy. The electrical energy is provided to the power source 201 for charging. During times of charging, current flows from the photocell 116 to the power source 201 to store energy in the power source 201.

The charging current is sensed or measured by the measuring circuit 221. The measuring circuit 221 receives the charging current and outputs a signal or information corresponding to the level or amount of the charging current to the processor 209. For example, the measuring circuit 221 includes a power amplifier and/or other circuitry or components. Other current measuring sensors, detectors, or circuits may be used.

The processor 209 correlates the output from the measuring circuit 221 with stored or predetermined values to determine or identify a value or amount of current charging the power source 201. For example, a look-up-table or other correlation technique is used. The processor 209 is a general processor, application-specific integrated circuit (“ASIC”), digital signal processor, field programmable gate array (“FPGA”), digital circuit, analog circuit, or combinations thereof. The processor 209 is one or more processors operable to control and/or communicate with the various electronics and logic of the light 104.

The processor 209 also monitors an output voltage of the photocell 116. For example, the processor 209 is connected with the output of the photocell 116 to measure or correlate an output voltage that is used to charge the power source 201. The processor 209 determines an amount of energy or power charged in the power source 201 as a function of the charging current and charging voltage provided by the photocell 116.

Because the processor 209 determines the amount of energy or power charged in the power source 201, the processor 209 may determine a runtime or operation time of the power source 201 for illuminating the light source 217. For example, predetermined or measured information or data correlating charge energy and output performance for various loads may be stored in the processor 209, such as in a look-up-table. Alternatively, the data or correlation information may be stored in a separate memory in communication with the processor 209. The processor 209 may also be connected with an output of the power source 201 to monitor output voltage during operation or discharge of the power source 201.

The power circuit 213 is connected with the power source 201 and the processor 209. The power circuit 213 may provide an increased current and/or voltage to the light source 217. Also, the power circuit 213 may act as a switch to disconnect and connect power to the light source 217. For example, the power circuit 213 includes a transistor or other switch and other passive components such as resistors, inductors, capacitors, diodes, and/or other components.

The light source 217 is connected with the power circuit 213. The light source 217 is one or more LEDs, incandescent bulbs, or other devices that emit light. For example, the light source 217 is two LEDs connected in series.

The processor 209 may control as runtime or operation length of the light source 217. For example, the processor 209 intermittently switches the light source 217 on and off (via the power circuit 213) using a pulse width modulated signal at a desired duty cycle. A lower duty cycle will result in a decreased brightness from the light source 217 but will use less energy from the power source 201, and a higher duty cycle will result in an increased brightness from the light source 217 but will use more energy from the power source 201. Because the processor 209 is aware of the amount of energy or charge in the power source and knows the correlation of runtime and energy, the processor 209 may control the runtime of the lights source by changing the output or brightness level of the light source 217.

For example, the processor 209 may operate the light source 217 all night by using a lower duty cycle (lower brightness), or the processor 209 may operate the light source 217 at full brightness irrespective of time. Different combinations may be achieved, such as operating the light source 217 at full brightness for a portion of time (e.g., early evening) and then operating the light source at reduced level or brightness (e.g., for the remaining part of the night). Alternatively, the processor 209 may use phase control or other switching signals or techniques other than a pulse width modulated signal.

The processor 209 may also include other features. For example, solar or light energy levels received by the photocell 116 at different times of a day may be used by the processor 209 to determine or calculate an approximate time of day and/or season of the year. The processor 209 may use data from a plurality of days and/or nights to determine such information. The time of day and/or season information may be used to implement turn on and turn off functions of the light 104.

Also, power source efficiency or health may be determined. The processor 209 may compare the discharge and charge voltages and/or currents with known or predetermined discharge and charge information to determine if the power source 201 is operating efficiently or below standard operation. If power source 201 is determined to be inefficient, damaged, or operating irregularly, a user may be notified by an LED, such as by blinking the light source 217, or other visual and/or audio indication.

Additionally, because the processor 209 monitors the output voltage of the power source 201 during operation times, the processor 209 may constantly switch off the light source, such as by the power circuit 213, when the output voltage of the power source 201 reaches a predetermined minimum value. By shutting off the light source 217 at a minimum operating voltage, the power source 201, such as a battery, may be protected from damage and/or may have an increased life span.

The processor 209 may also have an on-board temperature measuring circuit or device. The temperature circuit may be used to compensate for increased or decreased environmental temperatures and/or operation temperatures of the components of the light 104. For example, the processor 209 may include temperature versus power source operation information, such as in a look-up-table, or the correlation information may be stored in a separate memory. The processor 209 may compensate for varying temperatures during operation of the light source 217, such as by adjusting the pulse width modulated signal as a function of temperature. Alternatively, external or separate temperature circuits and/or sensors may be used.

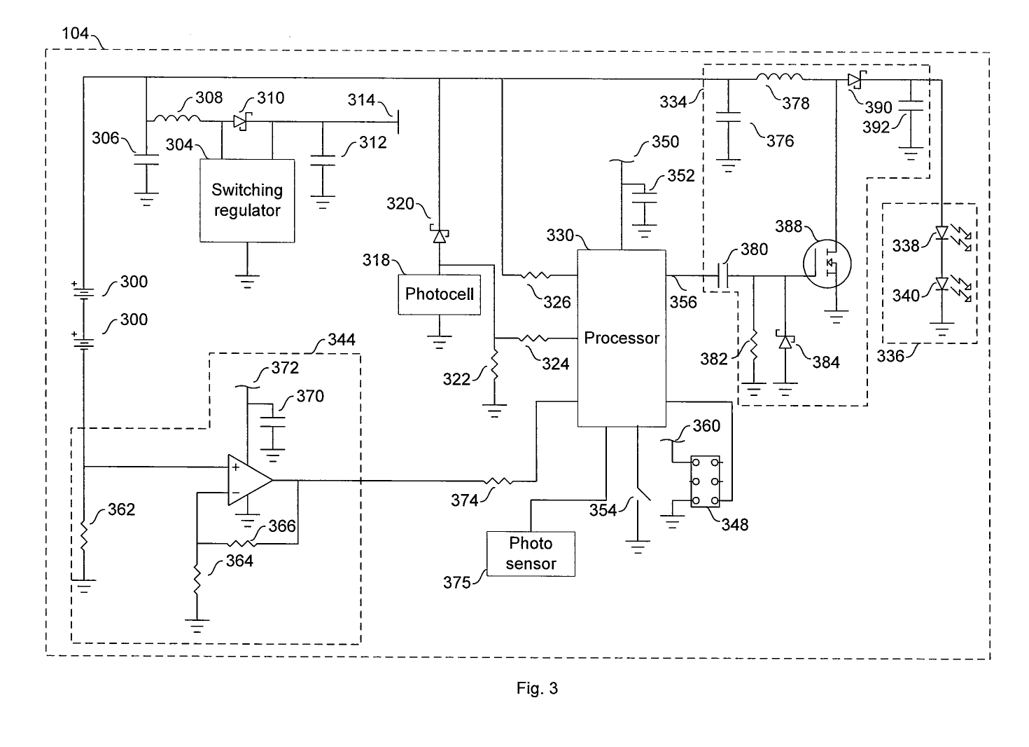

FIG. 3 is a circuit schematic of the light 104. For example, two rechargeable batteries 300 are connected in series. Each battery 300 is Nickel based and rated at 1.25 volts and 900 mAH. Other capacity and voltage batteries may be used. The batteries 300 combined are able to output 2.5 volts. Fewer or more batteries may be used for providing a lower or higher voltage.

The output of the batteries 300 are connected with a switching regulator 304. The switching regulator 304 converts the voltage from the batteries to a higher direct current (“DC”) voltage 314, such as 3.3 VDC. The output voltage 314 of the switching regulator is used to power other components of the light 104. The switching regulator 304 is biased by capacitors 306 and 312, an inductor 308, and a diode 310. The capacitor 306 has a capacitance of 33 pF, the capacitor 312 has a capacitance of 10 pF, and the inductor 308 has an inductance of 100 pH. Alternatively, other values may be used. The diode 310 may be a Schottky diode and is used by the switching regulator. Some or all of the diodes described herein may be Schottky diodes or other type of diodes.

The batteries 300 are also connected with a photocell 318. The photocell 318 is similar to the photocell 116. A diode 320 is used to prevent current backflow to the photocell 318 from the power source 300. The output of the photocell 318 is also connected with the processor 330 via a voltage divider including resistors 322 and 324. The voltage divider allows the processor 330 to monitor the photocell 318 output voltage. The resistors 322 and 324 have a resistance value of 10 K Ohms each. Alternatively, other resistance values may be used. Alternatively, an additional photocell 375, such as a silicon phototransistor or CDS photocell, may be utilized to determine light levels.

A measuring circuit 344 is connected between the batteries and the processor 330. The measuring circuit 344 is similar to the measuring circuit 221. For example, the measuring circuit 344 is used to measure charging current flowing from the photocell 318 to the batteries 300. The measuring circuit 344 includes an amplifier 368 that is biased by resistors 362, 364, and 366, and a capacitor 370. Fewer, more, or different components may be provided. The amplifier 368 is an operational amplifier that is power by a voltage 372. The voltage 372 may be the same as the voltage 314. The amplifier 368 amplifies the charging current and provides the amplified current to the processor 330 via a resistor 374. The resistor 362 has a resistance of 0.1 Ohms, the resistor 364 has a resistance of 1 K Ohms, the resistor 366 has a resistance of 199K Ohms, the resistor 374 has a resistance of 10 K Ohms, and the capacitor 370 has a capacitance of 0.1 μF. Alternatively, other values may be used.

The processor 330 is powered by a voltage 350 and a capacitor 352. The voltage 350 is the same as the voltage 314, and the capacitor 352 has a capacitance of about 0.1 μF. The processor 330 may be structurally and functionally similar to the processor 209. The processor 330 is connected with the output of the batteries 300 via a resistor 326 to monitor an operating voltage of the batteries 300. The resistor 326 has a resistance value of about 10 K Ohms.

A switch 354 and connector 348 also connect with the processor 330. The switch 354 is a single or multi-pole, push button, and/or other switch that can change a mode of operation of the light 104. For example, the switch 354 may be selected to allow the light 104 to operate at a maximum brightness mode, for a desired time period (e.g., all night), or a combination of both. The switch 354 may also be used to manually turn off or on the light 104. The connector 348 is used to debug or program the processor 330. For example, the connector 330 is powered by a voltage 360, which is the same as or different than the voltage 314, and includes six pins. Fewer or more pins may be provided.

The processor 330 operates a light source 336 via an output pin 356. The processor 330 outputs a pulse width modulated signal or other switching signal that is used to control current through an inductor 378. By varying the pulse width of the switching circuit 334, different current levels may be coupled with the light source 336, efficiently controlling brightness. For example, a switching or power circuit 334, which may be similar to the power circuit 213, is connected with the processor 330 via the pin 356. Alternatively, more pins, ports, or outputs may be used.

The switching circuit 334 includes a transistor 388 that is biased by a capacitor 380, a resistor 382, and a diode 384. These components may prevent the transistor 388 from being turned on constantly. The switching circuit 334 also includes a capacitor 376, the inductor 378, a diode 390, and a capacitor 392. Fewer, more, or different components may be provided. The output signal from the processor 330 intermittently switches the transistor 388 on and off, which effectively disconnects and connects the power, such as via the inductor 378. Also, the transistor 388 and the biasing components step up or increase a voltage or current to the light source 336. Alternatively, the switching circuit 334 may be a switch that disconnects or connects the light source 336 from a power source. However, switching the light source on and off may be less efficient due to power supply response restrictions.

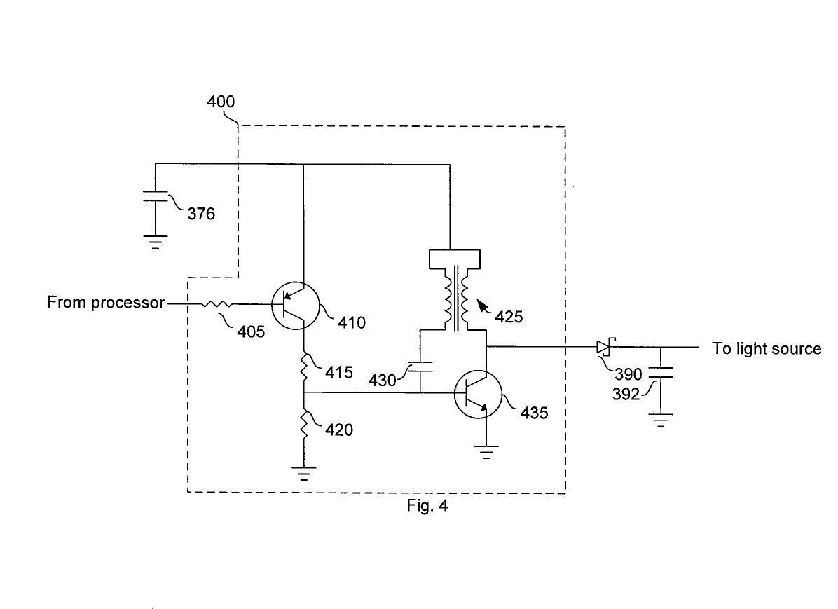

FIG. 4 is an alternative switching circuit 400 that may be in communication with the processor 330. The alternative switching circuit 400 includes a self oscillating power circuit. The self oscillating power circuit includes a transformer 425. The primary of the transformer is coupled to the base on an NPN transistor 435 via a 0.003 uF capacitor 330. The secondary of the transformer 425 is directly coupled to collector of the NPN transistor 435. The emitter of the NPN transistor is coupled to ground. In this configuration, a sinusoidal power voltage is present on the collector of the NPN transistor 435 when the self oscillating power circuit is allowed to oscillate.

The alternative switching circuit also includes a control circuit for enabling and disabling the self oscillating power circuit. The control circuit includes a 100 KΩ resistor 405 coupled to the base of a PNP transistor 410, a 2.2 KΩ resistor 415 coupled at one end to the collector of the PNP transistor 410 and at the other end to the base of the NPN transistor 435. The other end of the 2.2 KΩ resistor 415 is also coupled to a 1 MΩ resistor 420 to ground. The control circuit is utilized to enable and disable the self oscillating circuit. For example, when a low voltage is communicated from the processor to the control circuit, the self oscillating power circuit may be disabled. Conversely, when a high voltage is communicated from the processor to the control circuit, the self oscillating power circuit may be enabled.

Returning to FIG. 3, the capacitor 376 has a capacitance of about 33 μF, the capacitor 380 has a capacitance of about 0.1 μF, the capacitor 390 has a capacitance of about 10 μF, and the inductor 378 has an inductance of about 100 μH. The diodes 384 and 390 are used as pass and protection devices. The transistor 388 is a MOSFET, JFET, PNP, NPN, or other transistor.

The light source 336 is connected with the switching circuit 334. The source 336 includes two LEDs 338 and 340 connected in series. The light source 336 may include fewer or more LEDs and/or may include a different device that emits light. The LEDs may produce one or more output light colors.

The electrical circuits described above may include parts or components manufactured by Freescale Semiconductor, Inc., Motorola, Inc., National Semiconductor Corp., Infineon Tech., and/or other manufactures. For example, the processors described above may include a MC9S08 series micro-processor from Freescale Semiconductor, Inc.

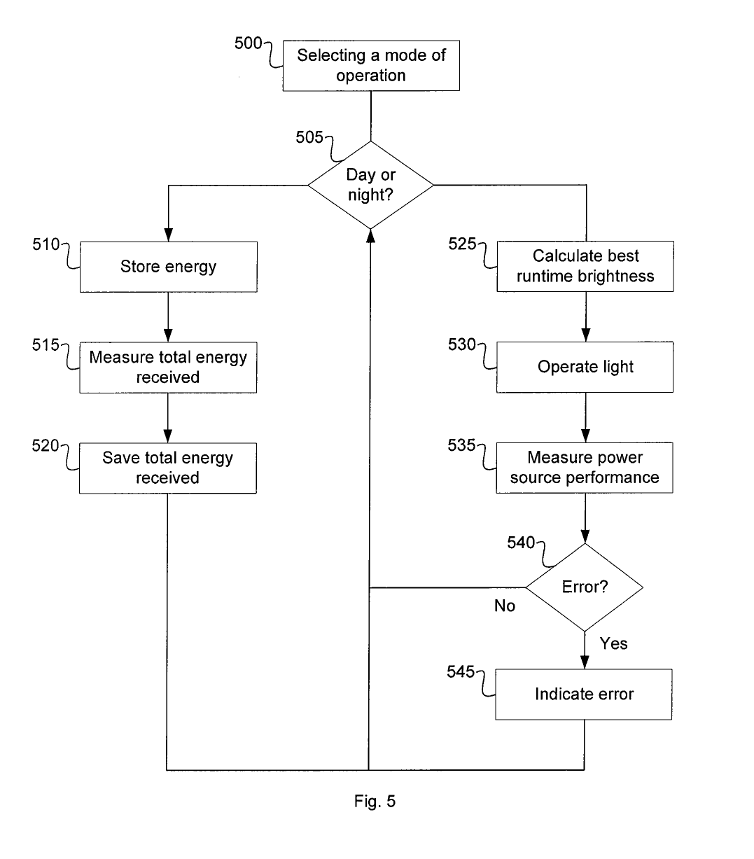

FIG. 5 is a flowchart illustrating a method for controlling at least one of the plurality of lights 104. Fewer, more, or different blocks or acts may be provided. At block 401, a mode of operation is selected for one or more lights, such as the lights 104 of FIG. 1. For example, a user activates a switch, such as the switch 354, on or in communication with one or more lights. The activation of the switch commands the light to operate at full brightness, for a desired period of time, or a combination of both. Alternatively,

At block 505, a determination is made as to the time of the day. If it is day time, then at block 510, energy or power is stored in the light. For example, a solar or photocell, such as the photocell 116 or 318 or the photo sensor 375, receives sunlight, or other light, such as during a daytime period. The photocell converts the light energy into electrical energy and charges a power source within the light, such as a battery and/or the power source 201 or 300.

At block 515, while the power source is charging, charging information is received or measured by the light. For example, a processor, such as the processor 209 or 330, of the light monitors, measures, compares, or determines a voltage and current from the photocell used to charge the power source. The processor uses the charging information to determine or correlate output or brightness levels as a function of an amount of energy or charge stored in the power source. For example, the processor or a separate memory contains data relating charge or energy with operation of a light source at different output levels or loads.

At block 520, the total amount of charge available is stored. For example, data correspond to the total amount of charge available in the light may be stored in a memory in communication with the processor. After the information is stored, the operations at block 505 are repeated.

At block 505, if a determination is made that it is night time, then at block 525 the best runtime brightness may be calculated. For example, the processor may retrieve the data associated with the total charge available in the light stored at block 520. The processor may then determine the best possible brightness of the light given the amount of available charge.

At block 530, an output level of a light source, such as the light source 217 or 336, is controlled as a function of the amount of energy stored or charged in the power source. For example, the processor may determine a duty cycle of a pulse width modulated signal that can be use to operate the light source for a desired period of time, such as intermittently turning the light source on and off via a switching circuit. For example, if the light was selected to run or operate during an entire evening or night (at block 401), the processor may determine a duty cycle that operates the light source at a lower brightness level so that the power source will be able to power the light source the entire evening. The pulse width modulated signal intermittently switches a switch on and off that is connected to with the light source via a power and/or switching circuit. Changing the duty cycle of the signal effectively changes a brightness level of the light source. However, if full brightness is desired, the processor may select a high duty cycle for the power and/or switching circuit that may provide a full brightness. By operating the light at full brightness, the power source may not be able to operate the light during the entire evening. Alternatively, the processor may operate the light source in a combination mode, such as operating the light source at full brightness for a period of time and then operating the light source at any brightness level that will last for a desired period of time.

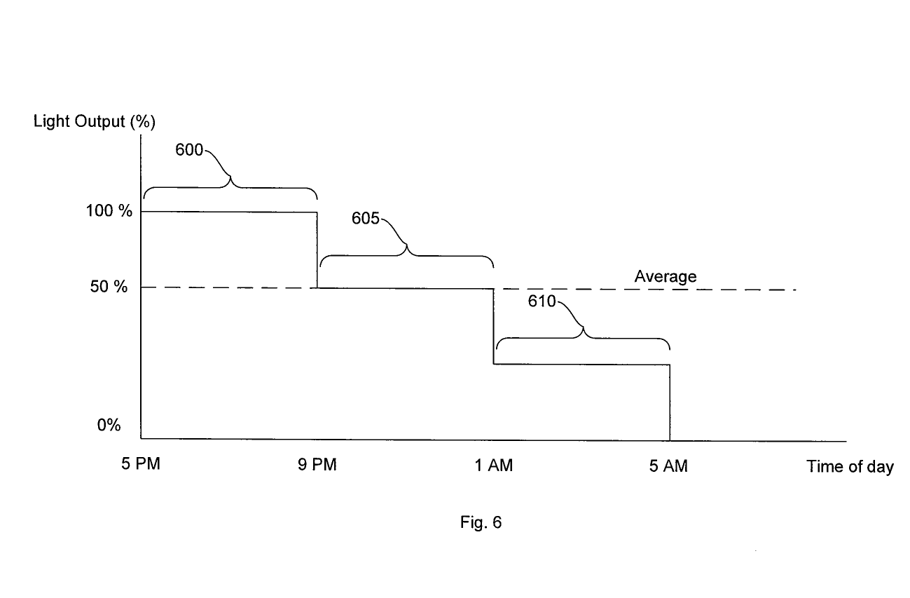

FIG. 6 depicts the light level associated with one group of exemplary operations of the light. During a first mode of operation 600, the light is operated at 100% light output. This light output may correspond to the best runtime brightness calculated at block 525. In the exemplary operation, the first mode of operation occurs corresponds to 5 PM and 9 PM. This time period may correspond to a time of day when security is paramount to an individual, such as a home owner arriving home from work after sunset.

During a second mode of operation 605, the illumination intensity is decreased. The time of day associated with the second mode of operation may correspond to a time of day when individuals are less concerned about security, but would still enjoy the effect that out door lighting brings.

Finally, during a third mode of operation 610, the lights may be lowered further. For example, the lights may be lowered when individuals are sleeping. Operating the light according the modes of operations described above utilizes the stored power in a way that provides the maximum benefit to an end user of the light.

Returning to block 530 in FIG. 5, other operations may be performed. For example, the processor may determine turn off or turn on times based on energy or charged information. The processor may calculate a rough time of day or season based on patterns of light being received by the photocell and charging of the power source. A turn off or turn on function may be implemented, such as a timer function, based on the calculated data. Alternatively, a user may manually switch power to the light on or off. Alternatively, an additional photocell, such as a silicon phototransistor or CDS photocell, may be utilized to determine turn on or turn off times.

Finally, the processor may also compensate for temperature changes while controlling the output level of the light source. For example, the processor may adjust the pulse width modulated signal as a function of temperature to maintain desired output levels and/or desired operation times. Temperature correlation data may be stored in the processor or other circuitry.

At block 535, the processor may measure the performance of the power source. For example, the processor may measure how quickly power storage devices, such as batteries, are discharged. This may enable maximizing the useful life of the power storage devices. For example, in the case of nickel cadmium (NiCad) batteries, damage may occur to the batteries if they are allowed to discharge below a specified minimum threshold. As another example, the processor may be programmed with default parameters that characterize the power source and may modify the defaults based on the measured power source performance. For example, the processor may determine after several periods of use, that the batteries are not holding as much charge as they held initially. This information may be utilized calculate the best runtime brightness calculated at block 525.

In block 540, a determination is made as to whether the power source is operating irregularly. For example, the processor may compare the charging and operating signals, voltage, and/or current of the power source with predetermined or model power sources. The comparison may be used to determine if the power source is healthy or behaving regularly. The power source may operate irregularly if there is an internal short, if the power source is reaching the end of its life, or if there is some other electrical, mechanical, and/or chemical problem.

At block 545, an irregularity is indicated to a user. For example, if the processor determines that the power source is operating irregularly, the processor and/or other circuitry may be used to flash or blink the light source or other light device to indicate an error or problem to a user. Alternatively, other visual or audio indicators or indications may be used. For example, a different color may be emitted from the light source.

Other features described above may be used for additional or other methods of use. Also, the features, components, and/or structures described above may be organized or identified in one or more methods of manufacture.

The logic, software or instructions for implementing the processes, methods and/or techniques discussed above may be provided on computer-readable storage media or memories or other tangible media, such as a cache, buffer, RAM, removable media, hard drive, other computer readable storage media, or any other tangible media. The tangible media include various types of volatile and nonvolatile storage media. The functions, acts or tasks illustrated in the figures or described herein are executed in response to one or more sets of logic or instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. The instructions may be stored on a removable media device for reading by local or remote systems. The logic or instructions may be stored in a remote location for transfer through a computer network or over telephone lines. Alternatively, the logic or instructions may be stored within a given computer, central processing unit (“CPU”), graphics processing unit (“GPU”) or system.

It is intended that the foregoing detailed description be regarded as illustrative rather than limiting, and that it be understood that the following claims, including all equivalents, are intended to define the scope of this design.

We claim:

1. An intelligent light fixture comprising:
a photovoltaic cell in communication with a power source, the photovoltaic cell receives and converts light energy into electrical energy to charge the power source;
a processor in communication with the photovoltaic cell; and
a light source in communication with the processor,
wherein the processor determines an amount of energy charged in the power source and operates the light source as a function of the determined amount of energy.

2. The intelligent light fixture of claim 1, wherein the light source is within a housing, the housing configured to be placed in an outdoor environment.

3. The intelligent light fixture of claim 1, wherein the processor determines the amount of energy charged based on a charging current provided by the photovoltaic cell.

4. The intelligent light fixture of claim 1, wherein the processor operates the light source to set a brightness level.

5. The intelligent light fixture of claim 4, wherein the processor maintains the brightness level by using a pulse width modulated signal.

6. The intelligent light fixture of claim 4, wherein the processor maintains the brightness level by setting a duty cycle of an output signal.

7. The intelligent light fixture of claim 4, wherein the processor maintains the brightness level by intermittently switching a power supply on and off, the power supply connected with the light source.

8. The intelligent light fixture of claim 4, wherein the brightness level changes in relation to a time of day.

9. The intelligent light fixture of claim 8, wherein the brightness level is linearly adjusted from a high level and lowered over time to a low level.

10. The intelligent light fixture of claim 8, wherein the brightness level is step-wise adjusted from a high level and lowered over time to a low level.

11. The intelligent light fixture of claim 4, wherein the brightness level changes in relation to a day of a week.

12. The intelligent light fixture of claim 4, wherein the brightness level increases as a detected amount of ambient light increases.

13. The intelligent light fixture of claim 4, wherein the brightness level decreases as a detected amount of ambient light decreases.

14. The intelligent light fixture of claim 1, further comprising logic stored in a memory that is operative to cause the processor to indicate a health of the power source.

15. The intelligent light fixture of claim 14, further comprising logic stored in a memory that is operative to disable the light source when the health of the power source is below a threshold.

16. An intelligent light fixture comprising:
a power source in communication with a processor; and
a light source in communication with the processor,
wherein the processor determines an amount of energy stored in the power source and operates the light source as a function of the determined amount of energy.

17. The intelligent light fixture of claim 16, wherein the light source is within a housing, the housing configured to be placed in an outdoor environment.

18. The intelligent light fixture of claim 16, wherein the processor operates the light source to set a brightness level.

19. The intelligent light fixture of claim 16, further comprising logic stored in a memory that is operative to cause the processor to indicate a health of the power source.

20. The intelligent light fixture of claim 19, further comprising logic stored in a memory that is operative to cause the processor to disable the light source when the health of the power source is below a threshold.
